(19) United States
(12) Patent Application Publication
(10) Pub. No.: US 2013/0125149 A1
(43) Pub. Date: May 16, 2013

(54) DATA PROCESSING APPARATUS

(71) Applicants: Kazuhito Shimomura, Fussa-shi (JP); Yuji Sakai, Yokohama-shi (JP)

(72) Inventors: Kazuhito Shimomura, Fussa-shi (JP); Yuji Sakai, Yokohama-shi (JP)

(73) Assignee: Kabushiki Kaisha Toshiba, Tokyo (JP)

(21) Appl. No.: 13/542,044

(22) Filed: Jul. 5, 2012

(30) Foreign Application Priority Data
Nov. 14, 2011 (JP) 2011-248934

(51) Int. Cl. G11B 17/04

(52) U.S. Cl. 720/601; G9B/17.062

(57) ABSTRACT

According to one embodiment, a data processing apparatus has a magazine, an optical disc drive, a transport mechanism, and an inner shell. The magazine stores a plurality of optical discs. The optical disc drive has an insertion portion to be closed with a tray for holding an optical disc. The transport mechanism transports the optical disc between the magazine and the optical disc drive. The inner shell includes a mounting portion for holding the magazine and a seal mechanism for closing a path communicating exterior and interior. The inner shell isolates at least the loading slot, the insertion portion and the transport mechanism from the exterior while the magazine is inserted in the mounting portion.

### CROSS-REFERENCE TO RELATED APPLICATIONS

This application is based upon and claims the benefit of priority from prior Japanese Patent Application No. 2011-248934, filed Nov. 14, 2011, the entire contents of which are incorporated herein by reference.

### FIELD

Embodiments described herein relate generally to a data processing apparatus having a function of removing any optical disc from magazine loaded a plurality of optical discs and then automatically setting another optical disc in an optical disc drive, thus replacing an optical disc with another.

### BACKGROUND

A data processing apparatus is known, which stores and provides a number of data items ranging from an item accessed at the highest frequency to an item accessed at the lowest frequency. All these data items are not necessary at all times. Hence, in this data processing apparatus, the data items accessed at high frequencies are stored in the hard disk drive, while the data items accessed at low frequencies or being important are periodically archived in optical discs. If the data so archived are needed, the data processing apparatus takes out the optical discs storing the data and sets the optical discs in a reading apparatus, whereby the data can be accessed.

Any data processing apparatus of this type is called “data library” or “archive changer.” It comprises magazine loaded a plurality of optical discs, an optical disc drive capable of writing and reading data in and from each optical disc, and a transport mechanism configured to move optical discs between the magazine and the optical disc drive. The data processing apparatus can use and hold more data if the magazine is exchanged with another.

If dust in the atmosphere sticks to any optical disc, it may become hard to record data in, or read data from, the optical disc. It is therefore necessary to clean periodically the optical system of the optical disc drive or the optical disc per se. In order to maintain the data processing apparatus in good conditions, the maintenance personnel may clean the optical disc or the optical system. An apparatus has been developed, which automatically clean the optical disc or the optical system.

The extent to which the optical disc or the optical system can be automatically cleaned is limited, nevertheless. Further, dust may enter the apparatus through an opening while magazine is replaced with another. So long as the cleaning is necessary and is performed, dust exists on the optical disc and in the optical system. While the cleaning is undergoing, the data processing apparatus cannot provide all or some pieces of service.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exploded, perspective view showing a data processing apparatus according to a first embodiment;

FIG. 2 is a side view of the data processing apparatus shown in FIG. 1;

FIG. 3 is a sectional view of the data processing apparatus, taken along line F3-F3 shown in FIG. 2;

FIG. 4 is a sectional view of the housing of the data processing apparatus, taken along line F4-F4 shown in FIG. 3;

FIG. 5 is a perspective view of the lower partition of FIG. 3, showing a portion where a wire hole is provided;

FIG. 6 is a sectional view of the wall of FIG. 5, showing the wire hole;

FIG. 7 is a sectional view showing the magazine mounting portion of the data processing apparatus shown in FIG. 2;

FIG. 8 is a sectional view of the magazine mounting portion shown in FIG. 7;

FIG. 9 is a sectional view of the magazine mounting portion shown in FIG. 8;

FIG. 10 is a sectional view of the magazine mounting portion of a data processing apparatus according to a second embodiment;

FIG. 11 is a sectional view of the magazine mounting portion shown in FIG. 10;

FIG. 12 is a sectional view of the magazine mounting portion of a data processing apparatus according to a third embodiment; and

FIG. 13 is a perspective view of a data processing apparatus according to a fourth embodiment, as viewed from the side at which the magazines may be inserted into the apparatus.

### DETAILED DESCRIPTION

Various embodiments will be described hereinafter with reference to the accompanying drawings.

In general, a data processing apparatus according to one embodiment comprises a magazine, an optical disc drive, a transport mechanism, an inner shell, and a gas supplying device. The magazine has a loading slot, through which a plurality of optical discs is loaded. The optical drive has an insertion portion closed by a tray that holds an optical disc, and reads and writes data from and in the optical disc. The transport mechanism transports an optical disc between the magazine and the optical disc drive. The inner shell has at least one mounting portion which holds the magazine and which connects the interior to the outside, and has a seal mechanism closing the junction between the interior and the outside. The inner shell isolates at least the loading slot, the insertion portion and the transport mechanism from the outside once the magazine has been attached to the mounting portion. The data processing apparatus is so constructed that dust can hardly enter the region where optical discs are handled.

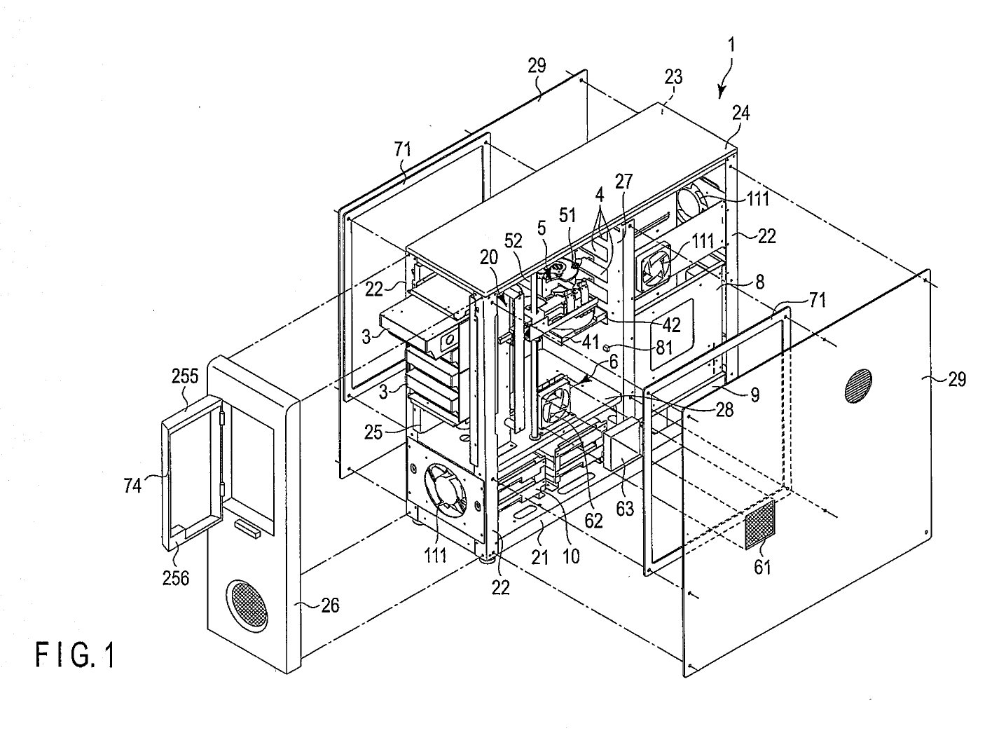

A data processing apparatus 1 according to a first embodiment will be described with reference to FIG. 1 to FIG. 9. In the FIG. 1, the data processing apparatus 1 is shown in a state in which a part of housing 2 is disassembled. The data processing apparatus 1 comprises magazines 3, an optical disc drive 4, a transport mechanism 5, inner shell 20, and a gas supplying device 6. The apparatus 1 has the housing 2, which includes a bottom panel 21, a frame 22, an upper partition 23, a top plate 24, a first partition 25, a face panel 26, a second partition 27, a lower partition 28, and a pair of side partitions 29. The inner shell 20 of the data processing apparatus 1 is formed in the housing 2 and composed of a plurality of partitions that constitute a part of the housing 2.

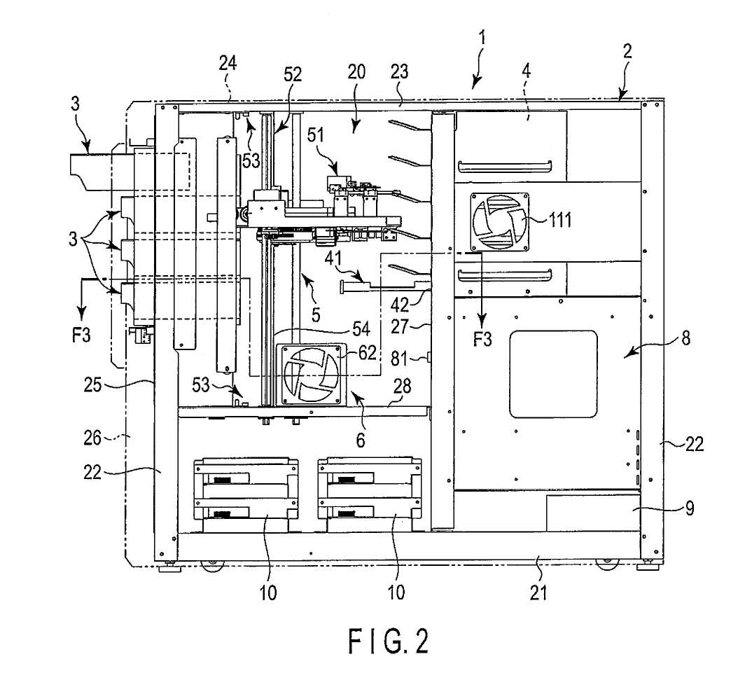

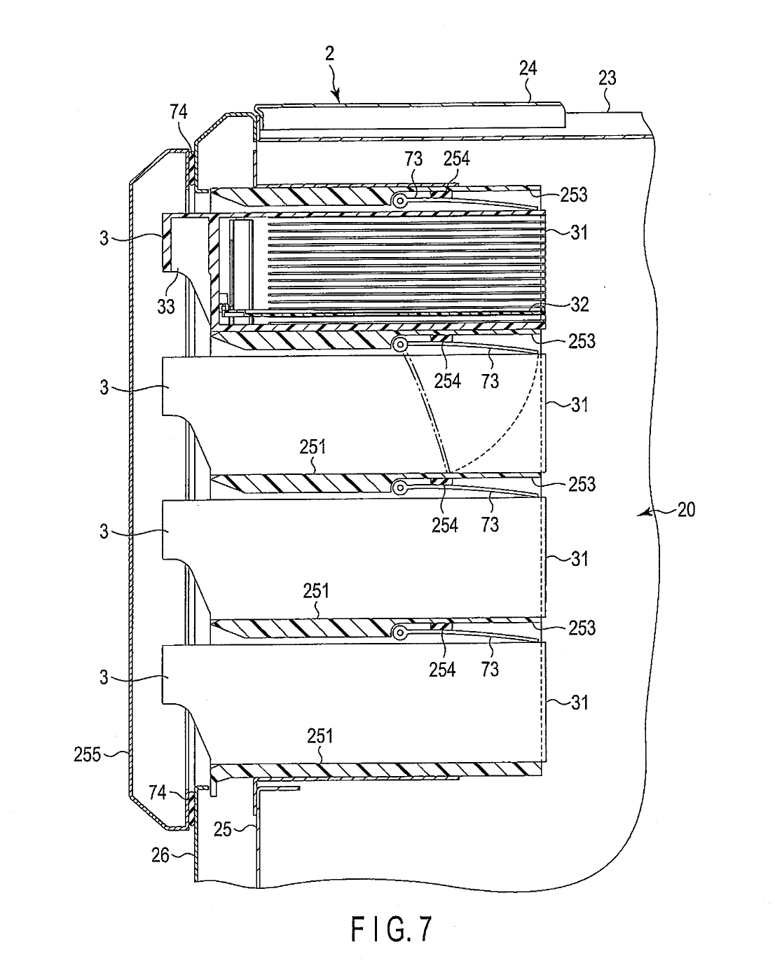

In this embodiment, the inner shell 20 is composed of the frame 22, first partition 25, second partition 27, lower partition 28, and pair of side partitions 29. The first partition 25 has mounting portions 251 for attaching the magazines 3, respectively. As shown in FIG. 1, FIG. 2 and FIG. 7, four mounting portions 251 are provided in the data processing apparatus 1 according to this embodiment. In FIG. 1 and FIG. 2, the magazine 3 inserted in the mounting portion 251 at the uppermost stage is pulled a little outwards.

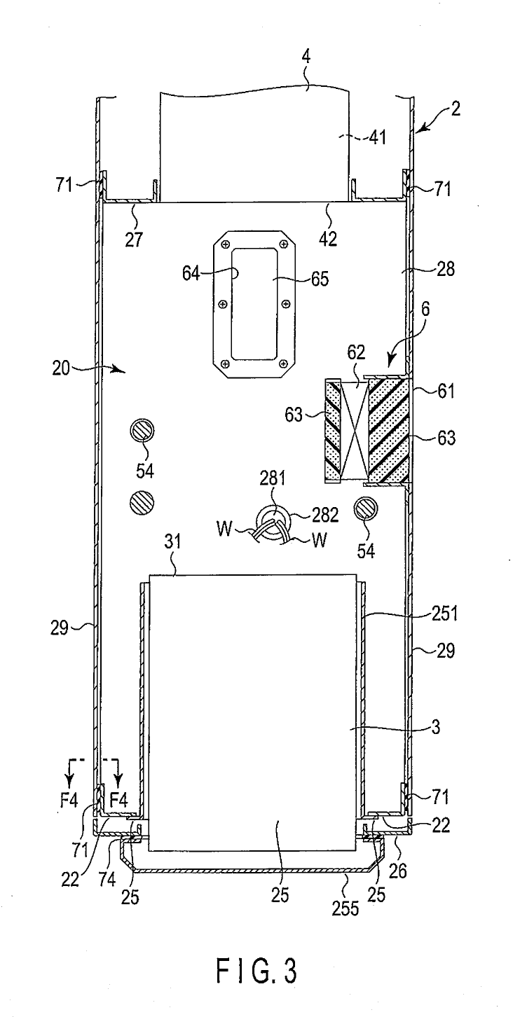

As shown in FIG. 2, the second partition 27 is arranged in almost center part of the housing 2 and extends parallel to the first partition 25. The second partition 27 is spaced apart from the first partition 25, across the transport mechanism 5. The optical disc drive 4 has an insertion portion 42, which is secured from outside the inner shell 20 as shown in FIG. 3. As shown in FIG. 2, the lower partition 28 supports the transport mechanism 5, and couples the first partition 25 and second partition 27 together. The upper partition 23 holds the upper end of the transport mechanism 5 and couples the first partition 25 and second partition 27 together.

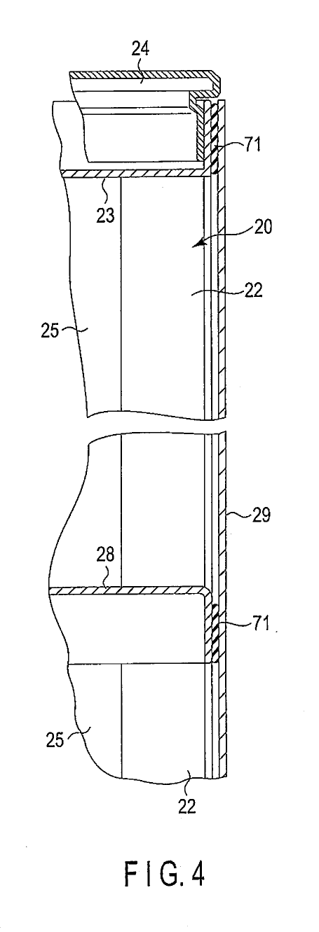

As shown in FIG. 1, the side partitions 29 are jointed to the bottom panel 21, frame 22, upper partition 23, first partition 25, second partition 27 and lower partition 28. Those parts of the side partitions 29, which are surrounded by the first partition 25, second partition 27, lower partition 28 and upper partition 23, constitute a part of the inner shell 20. In the first embodiment, the side partitions 29 may be released during the maintenance work performed on the data processing apparatus 1. Therefore, the side partitions 29 are jointed to the edges of the first partition 25, second partition 27, lower partition 28 and upper partition 23 with gaskets 71 as shown in FIG. 1, FIG. 3 and FIG. 4.

The gaskets 71 are seal members for an example, and are included in a seal mechanism that seals the passage between the exterior and interior of the inner shell 20. The gaskets 71 may be secured to the edges of the upper partition 23 and first partition 25, or to the side partitions 29. The gasket 71 may be seal members made of soft synthetic resin or foamed rubber, or may be packing having lips. Note that the “exterior” of the inner shell 20 means the space outside the partitions (i.e., first partition 25, second partition 27, upper partition 23, lower partition 28, and side partitions 29) that constitute the inner shell 20. Thus, any space except interior of inner shell 20, where includes any space outside of the housing 2 of the data processing apparatus 1, is the exterior even if the space is interior of the housing 2.

The junctions of the first partition 25 or second partition 27 and the upper partition 23 or lower partition 28 contact each other as if they were a flat plate and a flange, respectively. Hence, the corners of these junctions may be filled with caulking material if the inner shell 20 needs be more sealed, though no seal members are secured to these junctions in this embodiment. The junctions of the partitions constituting the inner shell 20 may be sealed with magnet tape. If magnet tape is used as a seal member, it can be repeatedly utilized whenever the maintenance is performed on the data processing apparatus 1.

The gas supplying device 6 supplies, into the inner shell 20, gas having smaller dust content than the gas existing outside the inner shell 20. In the first embodiment, the gas supplying device 6 includes at least an inlet port 61 made in the shell 20, a fan 62 for drawing the external gas into the inner shell 20 through the inlet port 61, and a filter 63 for filtering out dust from the external. As shown in FIG. 1 and FIG. 3, the inlet port 61 is made in one of the side partitions 29. The fan 62 is arranged in the inner shell 20. In this embodiment, the fan 62 is attached to a bracket that is secured to the lower partition 28 and aligned with the inlet port 61.

As shown in FIG. 3, two filters 63 are provided at the downstream and upstream of the fan 62 one by one. All external gas flowing through the inlet port 61 into the inner shell 20 therefore passes through the filters 63. Only one filter 63 may be used at the upstream of the fan 62 or at the downstream thereof, if it can filter out dust to lower the dust content to a tolerable value inside the inner shell 20. No filters 63 may be located between the inlet port 61 and the fan 62. In this case, a duct couples the side partition 29 to the fan 62. The filers 63 are, for example, HEPA filters. In the configuration of FIG. 3, the fan 62 is an axial-flow fan. Nonetheless, it may be another type appropriate in accordance with its position and the positions of the surrounding components and also with the flow rate at which the fan 62 should supply gas. It therefore suffices to arrange the filter 63 at the upstream or downstream of the fan 62.

The inner shell 20 is sealed with the seal mechanism that includes the gaskets 71. However, dust may be drawn into the inner shell 20 through narrow gaps when the external pressure or the external temperature changes. To prevent dusts from entering the inner shell 20 through such gaps, the fan 62 of the gas supplying device 6 keeps operating as long as the main power switch of the data processing apparatus 1 is on, thereby maintaining the pressure in the inner shell 20 at a value a little larger than the pressure outside the inner shell 20.

In order to guarantee that the pressure in the inner shell 20 is maintained higher than a predetermined value, the gas supplying device 6 includes a gauge 81 secured to the second partition 27 as shown in FIG. 1 and FIG. 2. The gauge 81 is a pressure sensor, for example a semiconductor element configured to detect a piezoelectric effect or a change in electrostatic capacitance. Alternatively, the gauge 81 may be a strain gauge. On the basis of the pressure detected by the gauge 81, the output of the fan 62 is controlled, maintaining the difference between the pressures inside and outside the inner shell 20 at a predetermined value. The position where the gauge 81 is secured is not limited to the second partition 27.

In order to positively remove dust which has been entered in the inner shell 20 when the inner shell 20 is opened by removing the side partition 29 for performing a maintenance on the data processing apparatus 1, the gas supplying device 6 of the first embodiment has an outlet port 64 which is provided on the inner shell 20 and a check valve 65 attached at the outlet port 64. As shown in FIG. 3, the outlet port 64 is opened in the lower partition 28. The check valve 65 is configured to prevent gas from flowing from outside into the inner shell 20. A diaphragm valve may be used as check valve 65, because it has a simple structure, and is not so bulky.

The gas supplying device 6 may include a dust counter to guarantee that the dust content is smaller than a preset value in the inner shell 20. The dust counter may be arranged near the outlet port 64 or at the position where is stagnant space in the inner shell 20. Alternatively, the dust counter may have a plurality of dust detection ports at several position in the inner shell 20 to sample the gas at these position, respectively, and used one after another ports in a specific order to detect dust. Still alternatively, a dust detection port may be arranged on the transport mechanism 5 that moves in the inner shell 20.

As shown in FIG. 1 and FIG. 2, the transport mechanism 5 is arranged between the magazines 3 and the optical disc drive 4. The transport mechanism 5 is configured to mount any optical disc from any magazine 3 onto the tray 41 of the optical disc drive 4 and to transport the optical disc back to the magazine 3 after used in the optical disc drive 4. The transport mechanism 5 comprises a pick-and-place mechanism 51 and a lift mechanism 52. The lift mechanism 52 is configured to move the pick-and-place mechanism 51 to a position in the magazine 3 or to a position in the optical disc drive 4 where the optical disc is stored. In order to move the pick-and-place mechanism 51, precisely to a desired position, distance sensors 53 are arranged on the upper partition 23 and the lower partition 28, respectively, as shown in FIG. 2. The lift mechanism 52 positions the pick-and-place mechanism 51 at high precision, in accordance with the distance measured by the distance sensors 53 and the volume of revolutions of the ball screw 54 of the lift mechanism 52.

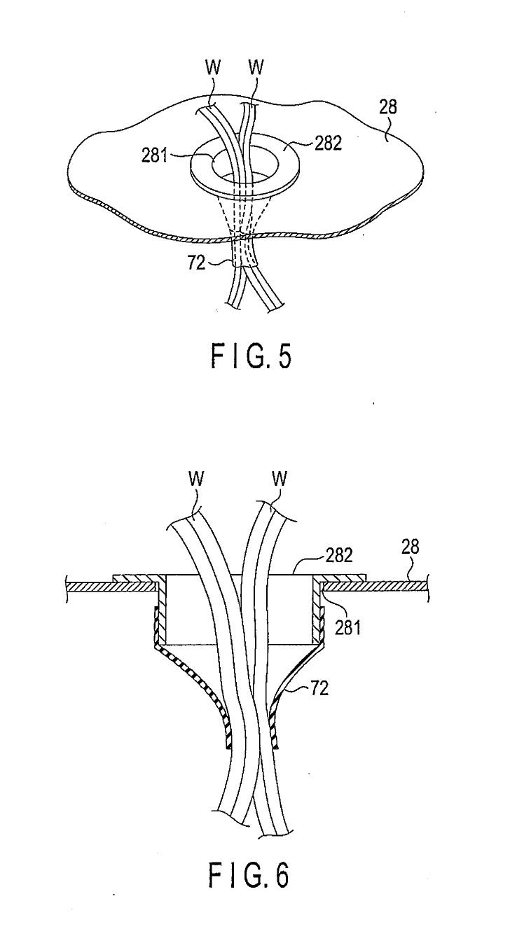

As shown in FIG. 3, FIG. 5 and FIG. 6, the lower partition 28 has an insertion hole 281 to be through wires W which are connected to the transport mechanism 5 and the gas supplying device 6 arranged in the inner shell 20. In the insertion hole 281, a guide 282 is fitted for protecting the sheaths of the wires W. The insertion hole 281 is a portion making the exterior and interior of the inner shell 20 communicate with each other. As shown in FIG. 6, a heat-shrinking tube 72 is fitted on a guide 282 extending outwards from the inner shell 20 and used as a seal mechanism in the first embodiment. The heat-shrinking tube 72 shrinks as shown in FIG. 6 when it is exposed to hot air coming from, for example, a drier after the wires W have been inserted into the guide 282. As a result, the gap between the guide 282 and the wires W is closed. The heat-shrinking tube 72 is used to prevent gas containing much dust from entering the inner shell 20. In view of this, a seal member, such as a plug made of rubber or foamed rubber stuck into the guide 282 and caulking material filled into the guide 282, may be used instead of the heat-shrinking tube 72 to close the gap between the guide 282 and the wires W.

The magazines 3 are cases, each for holding a plurality of optical discs. As shown in FIG. 7, each magazine 3 has a loading slot 31 through which an optical disc can be loaded onto, and removed from, a tray 32. In the first embodiment, the magazines 3 are provided in the same number as the mounting portions 251 opening at the first partition 25. Each magazine 3 can be replaced by another magazine 3 storing other optical discs when necessary. The magazines 3 may therefore prepared in greater number than the mounting portions 251. In this case, the magazines not held in the mounting portions 251 are stored outside the data processing apparatus 1.

As shown in FIG. 1 and FIG. 3, the optical disc drive 4 is an ordinary type that has a tray 41 for holding an optical disc. The optical disc drive 4 is configured to write and read data in and from the optical disc held on the tray 41. The optical disc drive 4 has an insertion portion 42, which is closed by the tray 41 while the tray 41 remains within the optical disc drive 4. If the insertion portion 42 is opened, or if the tray 41 is ejected, the optical disc drive 4 is exposed to an atmosphere in the inner shell 20. The optical system of the optical disc drive 4 may be assembled in the tray 41 or in the casing of the optical disc drive 4.

In the data processing apparatus 1 according to the first embodiment, it is necessary to prevent dust from sticking to any optical disc being moved in the inner shell 20 by the transport mechanism 5 between the magazine 3 and the optical disc drive 4, and to the optical system of the optical disc drive 4, which is exposed to the interior of the inner shell 20 as the optical disc is mounted on the tray 41 of the optical disc drive 4. Therefore, the inner shell 20 has to isolate at least the loading slot 31 of each magazine 3, the insertion portion 42 of the optical disc drive 4 and the transport mechanism 5 from the exterior.

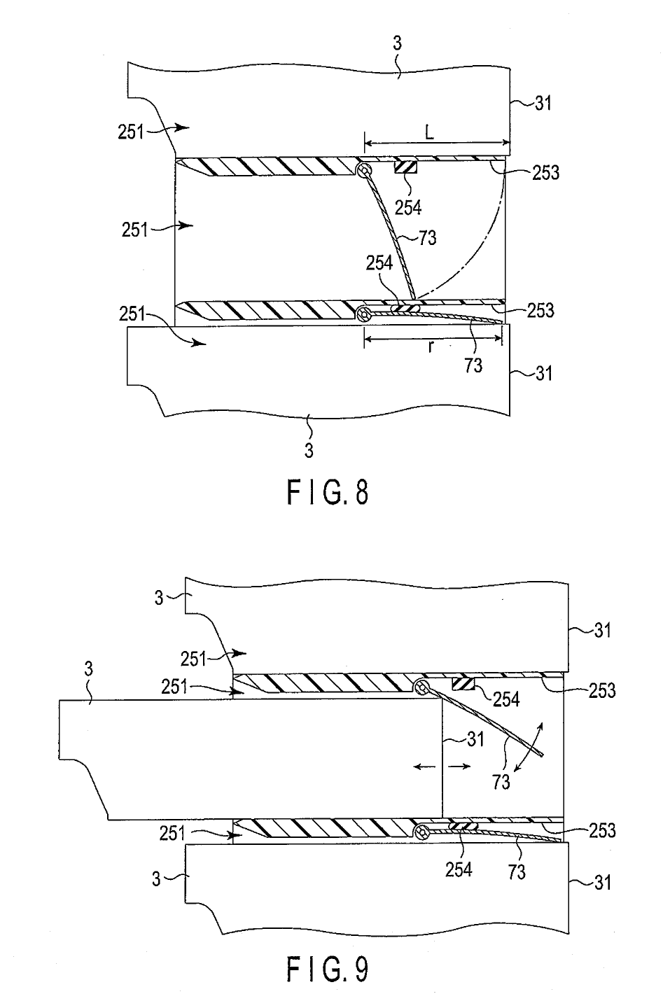

The mounting portions 251 into which the magazines 3 may be inserted, respectively, will be described with reference to FIG. 7 to FIG. 9. FIG. 7 shows the four mounting portions 251, and all of them are inserted a magazine 3, respectively. FIG. 8 shows one of the middle positioned mounting portions 251 provided in the first partition 25 with parts of two other mounting portions 251 which are located above and below the first-mentioned mounting portion 251, respectively. FIG. 9 shows how a magazine 3 is inserted into, or pulled from, the mounting portion 251 shown in FIG. 8. As shown in FIG. 8 and FIG. 9, two magazines 3 have been loaded in the upper and lower mounting portions 251, respectively.

In the data processing apparatus 1 according to the first embodiment, the inner shell 20 has shutters 73. The shutters 73 close the mounting portions 251, respectively, which become portions communicating the interior and exterior of the inner shell 20 when magazines 3 are extracted. The shutters 73 open to one direction and each are formed into the size enough to close the entire cross section of one mounting portion 251. As shown in FIG. 7 and FIG. 8, each shutter 73 is supported at the inner surface of the mounting portion 251 and can open as it rotates in the direction the magazine 3 is inserted into the unit 251. The shutters 73 are included in a seal mechanism that seals the exterior and interior of the inner shell 20 from each other.

In each mounting portion 251, the shutter 73 is supported on the inner surface of the mounting portion 251 at a location L distanced equal to or farther than its rotation radius r from the loading slot 31 of the magazine 3 which has been inserted in the mounting portion 251. Therefore, the shutter 73 will not interfere with the pick-and-place mechanism 51 of the transport mechanism 5 when the shutter 73 is pushed open as the magazine 3 is inserted into the mounting portion 251. That is, the radius r is less than the distance of the location L, i.e., r<L. As seen from FIG. 7 to FIG. 9, the shutter 73 is configured not to extend beyond the inner end 252 of the mounting portion 251 that protrudes into the inner shell 20. If the relation of r<L is satisfied, i.e., the shutter 73 does not project from the loading slot 31 of the magazine 3 when it is rotated to its full open position, the swinging end of the shutter 73 may lie beyond the inner end 252 of the mounting portion 251.

The inner wall of the mounting portion 251, at which the shutter 73 is supported, has a recess 253 in which the shutter 73 is shunted while a magazine 3 is inserted into the mounting portion 251. In the first embodiment, each shutter 73 hangs from the upper inner surface of the mounting portion 251. As shown in FIG. 7 and FIG. 8, an elastic member 254 is secured to the recess 253, preventing the shutter 73 from flattering due to the gas flowing between the magazine 3 and the mounting portion 251, while the magazine 3 is being held in the mounting portion 251. The elastic member 254 pushes the shutter 73 onto the magazine 3. The elastic member 254 is made of soft rubber or foamed elastomer, and can ensure the sealing between the shutter 73 and the recess 253.

The elastic member 254 may not be used at all. In this case, the shutter 73 is made of flexible material and is more curved than the gap between the magazine 3 and the recess 253. Once the magazine 3 has been loaded into the mounting portion 251, the middle part of the shutter 73 contacts the bottom of the recess 253. At the same time, the swinging end of the shutter 732 contacts the magazine 3. As a result, the shutter 73 closes the gap between the magazine 3 and the bottom of the recess 253, by virtue of its own elasticity.

When the magazine 3 is pulled from the mounting portion 251, the shutter 73 closes the mounting portion 251, by its weight, as shown in FIG. 8. Since the shutter 73 is pushed with the pressure existing in the inner shell 20, the shutter 73 can easily remain in the closing position. When the magazine 3 is inserted into the mounting portion 251, an end of the loading slot 31 of the magazine 3 pushes the shutter 73 as shown in FIG. 9, and rotates the shutter 73 to the opening position. In order to load a rotation force to the shutter 73 positively in the closing direction, a torsion coil spring or a formed wire spring may be attached to the shutter 73.

The shutter 72 is opened when the magazine 3 is inserted to a position where it contacts the shutter 73. That is, while the shutter 73 remains open, the magazine 3 always closes the mounting portion 251. In addition, the shutter 73 is always closed before the magazine 3 is pulled out from the mounting portion 251. Since the shutter 73 is used as sealing mechanism, the interior of the inner shell 20 therefore protected from dust floating outside even after the magazine 3 has been pulled out from the mounting portion 251.

Each magazine 3 has a handle 33 on the end portion opposite side to the loading slot 31. As shown in FIG. 7, the handle 33 protrudes from the face panel 26, helping the user to pull out the magazine 3 from the mounting portion 251. Since each mounting portion 251 is configured to be inserted the magazine 3 in and to be pulled out the magazine 3 from easily, a narrow gap exits between the mounting portion 251 and the magazine 3. This gap is narrow enough not to allow dust to enter the inner shell 20 in most cases as long as the gas supplying device 6 operates. As shown in FIG. 1, FIG. 3 and FIG. 7, the inner shell 20 includes a lid 255 which covers the magazine 3 inserted into the mounting portion 251 from the opposite side to the loading slot 31 in order to prevent dust from entering the inner shell 20 even if the main power supply of the data processing apparatus 1 is turned off.

As shown in FIG. 1, the lid 255 is coupled to the face panel 26 with hinges, and covers all magazines 3 that are loaded into the mounting portions 251 provided on the first partition 25. The face panel 26 is secured to the first partition 25 having almost no gap. Since a gasket 74 is provided between the lid 255 and the face panel 26, the gap between the magazine 3 and the mounting portion 251 is shut, as shown in FIG. 3 and FIG. 7. Thus, the gasket 74 is also included in the seal mechanism that closes the passage connecting the interior and exterior of the inner shell 20.

The lid 255 is equipped with a lock mechanism 256 which is released by key to prevent the any magazine 3 from carelessly being extracted from the mounting portion 251 while the transport mechanism 5 is loading any optical disc into, or removing the optical disc from, the magazine 3. The lock mechanism 256 is a so-called “key switch.” The lock mechanism 256 intervenes in controlling the transport mechanism 5 so as to temporarily stop the operation of the transport mechanism 5 when the lock mechanism is unlocked by the key.

The data processing apparatus 1 further comprises an electric circuit 8, a power supply 9, hard disk drives 10, and a heat radiator. The electric circuit 8 includes a control unit and a mother board. The control unit 8 controls the optical disc drive 4, the transport mechanism 5, and the gas supplying device 6. The mother board is such a type as generally used in computers. The power supply 9 may have, in addition to a power supply circuit, a secondary battery that supplies power for a shutdown operation at a blackout. The hard disk drives 10 are provided, each for temporarily storing the data read from the optical disc or the data to be written in the optical disc, by the optical disc drive 4, and also for storing data that is accessed at high frequency. The heat radiator is provided to remove the heat generated in the housing of the data processing apparatus 1. In this embodiment, the heat radiator comprises fans 111, which are provided at various positions, as shown in FIG. 1, to air-cool the optical disc drive 4, the electric circuit 8, the power supply 9 and the hard disk drive 10.

The data processing apparatus 1 is used as an archive changer. The archive changer is an apparatus, in which the transport mechanism 5 sets an optical disc in the optical disc drive 4 and the optical disc drive 4 records data in, or reproduces data from, an optical disc. Optical discs are advantageous not only in that they can easily store and hold data, but also in that they are inexpensive recording media. This is why the archive changer is often used in generally to store a great amount of data for a long time.

Recently, rules and institutions have been sophisticated for the storage and management of various data, such as medical data, insurance data, financial/account data and E-mail evidence data. Libraries and museums now need to have a system that provides electronic data about books and art objects, stores and manage image and music contents and personal-use data, and presents these contents and data. As one section of such a system, archive changers are used in increasing number. For use in such a system as describe above, the archive changer is demanded that it must be free of such malfunction that the data cannot be read out from the optical discs which should be archived the data, or that the data which should be archived cannot be written to the optical discs.

The data processing apparatus 1 according to the first embodiment, which is so configured as described above, has the function of keeping the region where optical discs are handled, i.e., inner shell 20, clean with less dust than outside. Hence, the number of times the maintenance work is performed on the optical discs and the optical system of the optical disc drive 4 can be reduced. Further, the shutter 73 is provided in each mounting portion 251 functioning as a seal mechanism. It is therefore preventing dust from entering the inner shell 20 when the magazine 3 is replaced by another. Since the amount of dust existing in the inner shell 20 is very small, it is provided a good environment, also for the optical system of each distance sensor 53 utilized to control the lift mechanism 52 of the transport mechanism 5.

Data processing apparatuses 1 according to the second to fourth embodiments will be described below. The components identical to those of the data processing apparatus according to the first embodiment will be designated by the same reference symbols, and detail description of them will be referred to the detail according to the first embodiment. Further, any configuration identical to the corresponding configuration of the first embodiment will be incorporated by referring to the drawings and corresponding description according to the first embodiment.

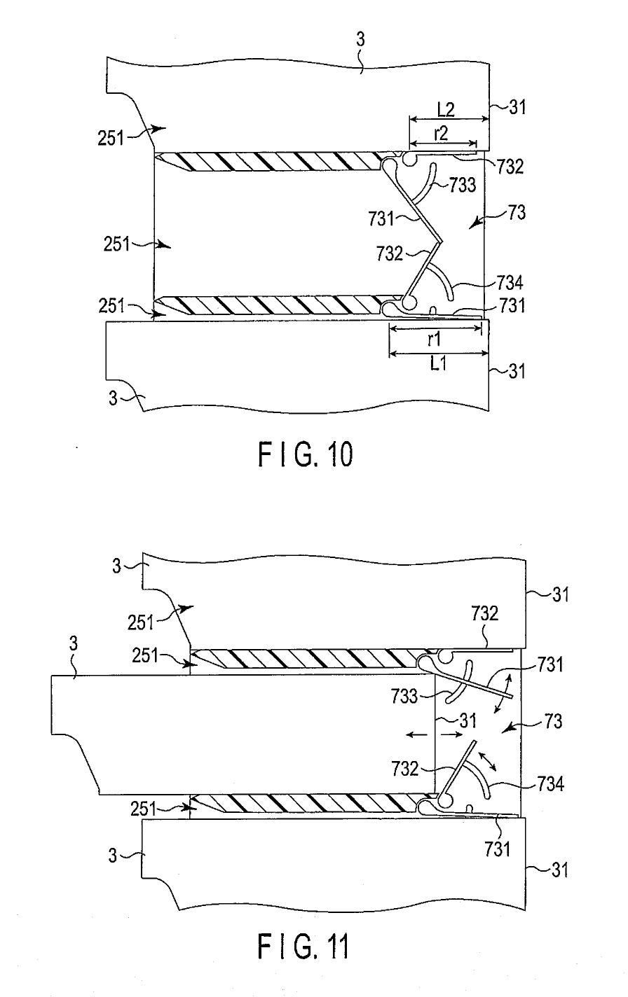

A data processing apparatus 1 according to the second embodiment will be described with reference to FIG. 10 and FIG. 11. FIG. 10 is a sectional view showing one of middle mounting portions 251 provided in the first partition of the inner shell 20 of the data processing apparatus 1, and parts of two other mounting portions 251 which are located above and below the first-mentioned unit 251, respectively. FIG. 11 shows how a magazine 3 is inserted into, or pulled out from, the mounting portion 251 shown in FIG. 10. As shown in FIG. 10 and FIG. 11, the upper and lower mounting portions 251 compared with the middle mounting portion 251 illustrated at mid portion of the drawings have been loaded the magazines 3, respectively.

In the data processing apparatus 1 according to the second embodiment, the shutters 73 can open to both sides, each composed of an upper shutter 731 and a lower shutter 732. Each shutter 73 can close the entire cross section of one mounting portion 251. The upper shutter 731 is supported at the upper wall of the mounting portion 251, and the lower shutter 732 is supported at the lower wall of the mounting portion 251. Both the upper shutter 731 and the lower shutter 372 are opened as they rotate in the direction the magazine 3 is inserted into the mounting portion 251. The lower shutter 732 must be closed against the gravity, and is therefore biased with a torsion spring or a formed wire spring. A torsion spring or a thin wire spring may be secured to the upper shutter 731 to make the shutter 73 operate stably. The shutter 73 is included in the seal mechanism as in the first embodiment.

The upper shutter 731 and the lower shutter 732 are configured to abut on each other, at rotational end, in their closed positions. In the second embodiment, each side wall of any mounting portion 251 has cam grooves 733 and 734 as shown in FIG. 10, in a region in which the upper shutter 731 and lower shutter 732 swing. The upper shutter 731 and the lower shutter 732 are limited the angle for swinging, because the projections, which are formed on side portion each of the upper shutter 731 and lower shutter 732, are set in engagement with the cam grooves.

As shown in FIG. 10, the rotation radius r1 of the upper shutter 731 is larger than the rotation radius r2 of the lower shutter 732 in the second embodiment. Like the shutters 73 used in the first embodiment, the upper shutter 731 and the lower shutter 732 are supported at locations L1 and L2 distanced equal to or farther than the rotation radii r1 and r2, respectively, from the loading slot 31 of the magazine 3 loaded in the mounting portion 251. This is obvious from the positions the upper shutter 731 of the lower mounting portion 251 and the lower shutter 732 of the upper mounting portion 251 take, as shown in FIG. 10, while they are pushed open by the magazine 3. The upper shutter 731 is supported at upstream side with respect to the lower shutter 732 as viewed in the direction that the magazine 3 is inserted into the mounting portion 251. That is, the upper shutter 731 and the lower shutter 732 have the relations of r1>r2, L1>L2, r1<L1 and r2<L2.

Hence, as the magazine 3 is inserted into the mounting portion 251, the upper shutter 731 first starts opening and the lower shutter 732 then starts opening as shown in FIG. 11. The force for opening the shutter 73 disperses, and the resistance generated when the magazine 3 is pushed into the mounting portion 251 is reduced, because the magazine 3 pushes the upper shutter 371 and the second shutter 732 at times a little different from each other. Further, as the magazine 3 is pulled from the mounting portion 251, the lower shutter 732 first starts closing, and the upper shutter 731 then starts closing. Eventually, the distal end of the upper shutter 731 abuts on the distal end of the lower shutter 732 already stopped with its projection held in the cam groove 734. Since the upper shutter 371 and the second shutter 732 operate at times a little different, the upper shutter 731 and the lower shutter 732 abut on each other at distal end, always in the same manner.

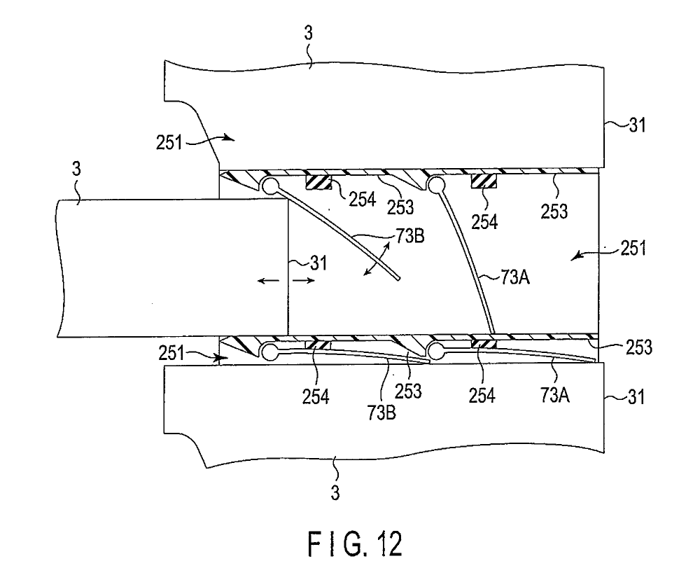

A data processing apparatus 1 according to the third embodiment will be described with reference to FIG. 12. FIG. 12 is a sectional view of the mounting portions 251 provided in the first partition of the inner shell 20 of the data processing apparatus 1. The one of the middle mounting portions 251 is shown in FIG. 12 with parts of two other mounting portions 251 which are located above and below the first-mentioned mounting portion 251. FIG. 12 also shows how a magazine 3 is inserted into, or pulled out from, the mounting portion 251. As shown in FIG. 12, the upper and lower mounting portions 251 illustrated above and below the mounting portion 251 located in mid portion in FIG. 12 have been loaded magazines 3 in, respectively.

In the data processing apparatus 1 according to the third embodiment, two shutters 73, i.e., downstream shutter 73A and upstream shutter 73B, are provided in each mounting portion 251 and arranged in the direction a magazine 3 is inserted into the mounting portion 251 as shown in FIG. 12. The downstream shutter 3A has the same structure as the shutter 73 used in first embodiment and is arranged at the same position as the shutter 73 arranged in the first embodiment. The upstream shutter 73B is positioned upstream with respect the downstream shutter 73A and has the same structure as the shutter 73 described in first embodiment. The upstream shutter 73B is spaced apart from the downstream shutter 73A, not to interfere with downstream shutter 73A. If the mounting portion 251 has a stoke sufficiently long in the direction the magazine 3 is inserted into the mounting portion 251, the upstream shutter 73B is arranged near the magazine insertion port of the mounting portion 251, and the downstream shutter 73A is arranged near the interior of the inner shell 20. The shutters 73A and 73B may be configured to open to both sides as in the second embodiment. Further, three or more shutters 73 may be arranged in the mounting portion 251, unless the mounting portion 251 become too complex in terms of structure.

In the data processing apparatus 1 according to the third embodiment, each mounting portion 251 has two seal mechanisms because two shutters 73 are arranged as shown in FIG. 12. Therefore, that part of each mounting portion 251, which lies between the downstream shutter 73A and the upstream shutter 73B, can be easily kept clean, and free of dust. Hence, the dust is prevented from being pushed into the inner shell 20 by inserting the magazine 3 into the mounting portion 251, even if dust enters the part of the mounting portion 251, which lies upstream of the downstream shutter 73A, while the magazine 3 is being replaced by another.

Whether the upstream shutter 73B has been opened or not may be detected. If the upstream shutter 73B is found opened, the part of the mounting portion 251 between the downstream shutter 73A and the downstream shutter 73B may be flushed with clean gas containing little dust. In this case, dust is removed also from the magazine 3. The inner shell 20 may be therefore easily kept clean, containing but a very small amount of dust.

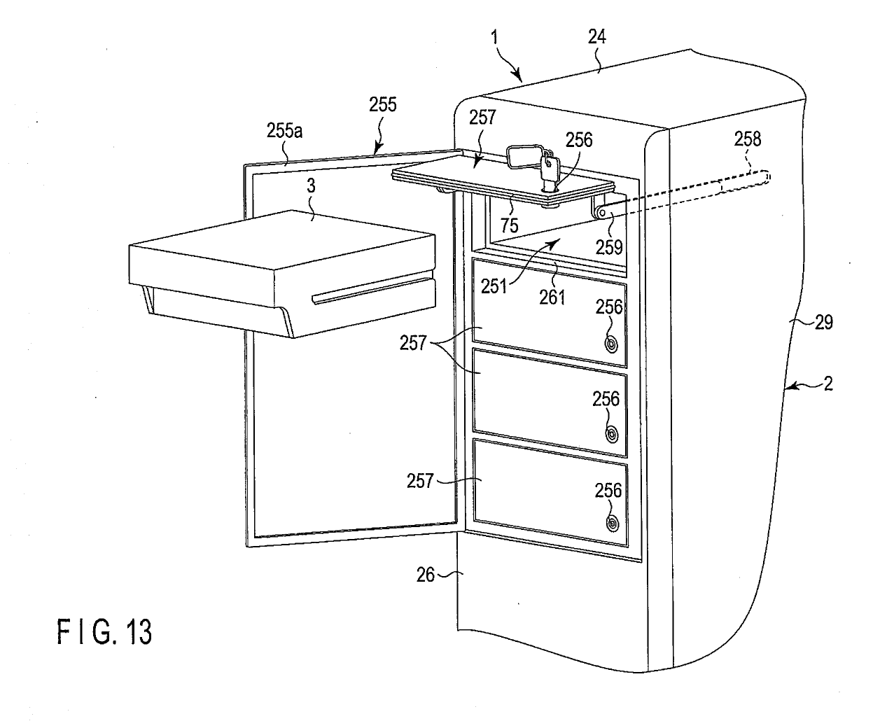

A data processing apparatus according to the fourth embodiment will be described with reference to FIG. 13. FIG. 13 is a perspective view of the data processing apparatus as viewed from the side at which the magazines may be inserted into the apparatus. As shown in FIG. 13, a magazine 3 has been extracted from the uppermost mounting portion 251. Each mounting portion 251 has a shutter 73 as seal mechanism which has the same construction in the first embodiment or second embodiment. In the data processing apparatus 1 according to the fourth embodiment, the lid 255 includes inner lids 257 as shown in FIG. 13, which are associated with the mounting portions 251, respectively. As shown in FIG. 13, the inner lid 257 for the uppermost mounting portion 251 is opened.

The face panel 26 has recesses 261 in which the inner lids 257 are fitted while assuming the closed position. Each inner lid 257 has a packing 75 attached at the peripheral portion. The packing 75 seals the gap between the internal surface of the recess 261 and the outer periphery of the inner lid 257. The packing 75 therefore performs the same function as the gasket 74 of the lid 255 does in the first embodiment. The inner lid 257 is rotatable, coupled to one slider 259 that is guided in the slot 258 made in the inner surface of the mounting portion 251. The inner lid 257 is first pulled to be opened in the direction the magazine 3 is extracted from the mounting portion 251 and then rotated upwards as shown in FIG. 13. When the inner lid 257 is so opened, a passage is ensured, through which the magazine 3 can be inserted into or pulled out from the mounting portion 251.

Each inner lid 257 has a lock mechanism 256 similar to the lock mechanism 256 provided for the lid 255 in the first embodiment. Therefore, the lock mechanism 256 must be unlocked with a key in order to open the inner lid 257 associated with the magazine 3 when the magazine 3 is replaced with another. One lock mechanism 256 is provided for the inner lid 257 attached to each mounting portion 251. This not only improves the sealing of the inner shell 20 at the time of exchanging magazines 3, but also increases the security level of data at the time of exchanging magazines 3. In the fourth embodiment, the lid 255 is provided to cover all inner lids 257. The lid 255 need not have so high sealing ability as in the first embodiment, because the inner lids 257 are provided for the mounting portion 251, respectively. Magnet sheets 255a are attached to the edges of the lid 255. The lid 255 is therefore secured to the face panel 26 with a magnetic force. Instead of attaching the magnet sheets 255a to the face panel 26, magnets may be embedded in the face panel 26 and the lid 255 may be made of magnetic material. In this case, too, the lid 255 is secured to the face panel 26.

In the data processing apparatus 1 according to the first embodiment, the gas supplying device 6 is a fan 62 that draws external gas into the inner shell 20 through the filter 63 from the inlet port 61 made in a partition of the inner shell 20. The gas supplying device 6 needs only to have the function of preventing dust from entering the inner shell 20, by supplying gas, which contain less dust than the gas that exist at the exterior, to the interior of the inner shell 20, and by maintaining the interior pressure of the inner shell 20 a little higher than the exterior pressure.

Hence, the gas supplying device 6 may includes a compressor, an accumulator, a gas supplying path, a pressure reducing valve. The compressor supplies compressed air. The accumulator temporarily reserves the compressed air, and has a volume large enough to maintain the pressure at a prescribed level, even while the compressor is not operating. Thus, the accumulator moderates pressure changes that occur when the compressor is switched to from the compressing mode to the non-compressing mode, or vice versa.

The filter removes dust from the compressed air passing through it. The filter can be arranged at any position between the downstream side of the compressor and a site where the compressed air is supplied into the inner shell of the data processing apparatus. To achieve high efficiency of exchanging filters, however, the filter should better be arranged outside the data processing apparatus.

The gas supplying path only needs to be connected to the interior of the inner shell 20 so that not only supplying enough volume of the compressed air to the inner shell 20 but also circulating the compressed air in the inner shell 20 to reach every corner thereof. In view of this, only one gas supplying path may be provided, or a plurality of gas supplying paths may be provided to supply compressed air from various points. Further, another gas supplying path may be provided, dedicated to flushing that is performed after the inner shell 20 has been opened for maintenance.

The pressure reducing valve is arranged on a middle part of the gas supplying path, and adjusts the flow rate of compressed air, making the pressure in the inner shell 20 slightly higher than the pressure outside the inner shell 20. Since the pressure reducing valve mechanically operates in accordance with a pressure difference, any pressure gauges need not be used. The pressure reducing valve operates the moment that the pressure in the inner shell 20 falls when the lid 255 is opened to extract any magazine 3 or any magazine 3 is removed from the mounting portion 251.

The gas supplying device 6 may further include a gas cylinder filled with inert gas or compressed air, instead of the compressor and accumulator. Nitrogen, carbon dioxide, argon or helium can be utilized as inert gas with ease. Any inert gas cylinder or compressed air cylinder available has been industrially prepared, the gas or air in the cylinder is considered containing less dust and water than the external gas. Hence, if an inert gas cylinder or a compressed air cylinder is used, the filter can be simplified in structure. Only one gas supplying path or more gas supplying paths may be used to supply gas to from the cylinder into the inner shell 20, as in the apparatus having both a compressor and an accumulator. If two or more gas supplying paths are used, the gas can be supplied into the inner shell 20 at several positions.

If a cylinder filled with inert gas or compressed air is connected to the inner shell 20, the pressure in the inner shell 20 of the data processing apparatus will be kept higher than the external pressure even if the main power switch of the data processing apparatus 1 is turned off or the main electric power is not available due to, for example, a power failure. The volume at which the cylinder can supply gas into the inner shell 20 is limited. In view of this, a gas supplying device 6 having a fan 62 or a gas supplying device 6 having a compressor and an accumulator may be combined with the pressurized cylinder. In this case, the fan 62 or the compressor is operated in normal conditions, and clear gas is supplied from the cylinder if electric power cannot be supplied to the gas supplying device 6 due to, for example, a power failure. The more the inner shell 20 of the data processing apparatus 1 is sealed, the longer the pressure in the inner shell 20 is maintained higher than the external pressure. Thus the data processing apparatus 1 may survive the long period when an emergency, for example, disaster causing the power failure, is occurred.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data processing apparatus comprising:
a magazine comprising a loading slot and configured to store a plurality of optical discs;
an optical disc drive comprising an insertion portion to be closed with a tray for holding an optical disc and configured to write and read data in and from the optical disc held on the tray;
a transport mechanism configured to transport the optical disc between the magazine and the optical disc drive; and
an inner shell comprising a mounting portion communicating between exterior and interior for holding the magazine and a seal mechanism for closing a part communicating between exterior and interior, and configured to isolate at least the loading slot, the insertion portion and the transport mechanism from the exterior while the magazine is being held in the mounting portion.

2. The data processing apparatus of claim 1, wherein
the mounting portion is included in the part communicating between the exterior and the interior; and
the seal mechanism comprises a shutter configured to close the mounting portion.

3. The data processing apparatus of claim 1, wherein
the inner shell comprises a plurality of partitions; and
the seal mechanism comprises seal members configured to close gaps between the partitions.

4. The data processing apparatus of claim 1, further comprising
a gas supplying device configured to supply gas containing less dust than the exterior gas, into the inner shell.

5. The data processing apparatus of claim 2, wherein
the shutter is supported at a location on an inner surface of the mounting portion, the location distanced from the loading slot of the magazine inserted into the mounting portion farther than dimensions of a rotation radius of the shutter, and the shutter is rotated in a direction in which the magazine is inserted and is thereby opened.

6. The data processing apparatus of claim 2, wherein
the shutter is configured to open to one side.

7. The data processing apparatus of claim 2, wherein
the shutter is configured to open to both sides.

8. The data processing apparatus of claim 2, wherein
at least two shutters are arranged in a direction in which the magazine is inserted.

9. The data processing apparatus of claim 1, wherein
the inner shell comprises a lid configured to cover the magazine loaded in the mounting portion at a side opposite to the loading slot.

10. The data processing apparatus of claim 9, wherein
the inner shell comprises a plurality of mounting portions, and
the lid is configured to cover all magazines held in the mounting portions.

11. The data processing apparatus of claim 9, wherein
the inner shell comprises a plurality of mounting portions, and
the lid comprises a plurality of inner lids configured to cover the mounting portions, respectively.

12. The data processing apparatus of claim 4, wherein
the gas supplying device comprises: an inlet port made in the inner shell; a fan configured to draw external gas through the inlet port; and a filter arranged upstream or downstream, or both, with respect to the fan, and configured to guide all external gas flowing from the inlet port and remove dust from the external gas.

13. The data processing apparatus of claim 12, wherein
the gas supplying device comprises a gauge configured to measure the pressure in the inner shell.

14. The data processing apparatus of claim 12, wherein
the gas supplying device comprises an outlet port made in the inner shell, and a check valve being secured in the outlet port, the check valve configured to prevent gas from flowing into the inner shell from the exterior of the inner shell.

15. The data processing apparatus of claim 4, wherein
the gas supplying device comprises: a compressor configured to output compressed air; an accumulator configured to reserve the compressed air; a filter configured to remove dust from the compressed air by passing through thereof; a gas supplying path configured to supply the compressed air from the filter; and a pressure reducing value provided midway in the gas supplying path and configured to adjust a flow rate of the compressed air, thereby to make the pressure in the inner shell higher than pressure outside the inner shell.

16. The data processing apparatus of claim 4, wherein
the gas supplying device comprises: a container in which either inert gas or compressed air is sealed; a gas supplying path configured to supply the gas or air into the inner shell; and a pressure reducing value provided midway in the gas supplying path and configured to adjust a flow rate of the gas or air, thereby to make the pressure in the inner shell higher than pressure outside the inner shell.
